(19) United States
(12) Patent Application Publication
(10) Pub. No.: US 2009/0277225 A1
(43) Pub. Date: Nov. 12, 2009

(54) Production of Glass

(75) Inventors: Lee Stanley Mangan, Northwood (GB); Robert Alan Williams, Ormskirk (GB)

Correspondence Address: MARSHALL & MELHORN, LLC, FOUR SEAGATE - EIGHTH FLOOR, TOLEDO, OH, 43604, US

(73) Assignee: Pilkington Group Limited, St.Helens (GB)

(21) Appl. No.: 12/086,443

(22) PCT Filed: Dec. 19, 2006
(86) PCT No.: PCT/GB2006/050466

§ 371 Date: Mar. 23, 2009

(30) Foreign Application Priority Data
Dec. 23, 2005 (GB) 0526175.5

(51) Int. Cl. C03B 23/00

(52) U.S. Cl. 65/66

(57) ABSTRACT

Soda lime silica float glass in ribbon form is produced at reduced cost by replacing at least part of the soda ash conventionally used as a source of sodium fluxing agent by calcined trona ore. The invention may use calcined trona ore from the deposits in the Green River Valley area of Wyoming, USA.

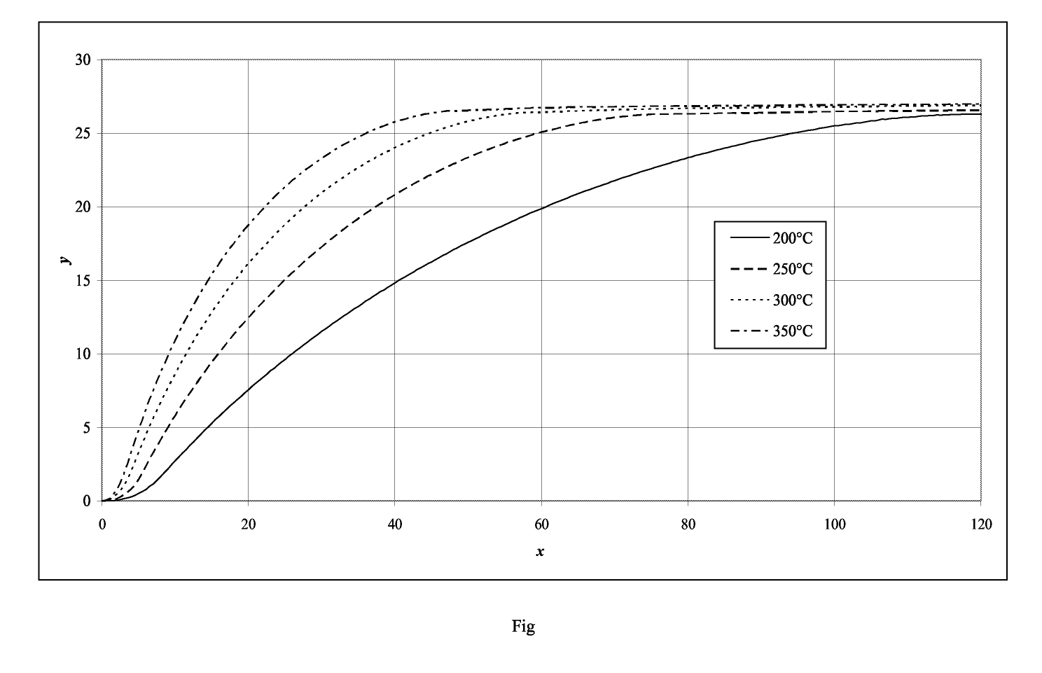

This invention relates to the production of soda lime silica glass using calcined trona ore as a constituent of the glass batch, especially to the production of float glass.

Soda lime silica glass is generally produced by melting a batch comprising soda ash (sodium carbonate (Na₂CO₃)), silica sand (SiO₂), a source of calcium and optionally a source of magnesium. At least some of the calcium may be provided as limestone (CaCO₃). Dolomite is frequently used as a source of both magnesium and at least some of the calcium required.

The soda ash may be produced synthetically, usually by the Solvay process, or it may be derived from a naturally occurring source such as nahcolite (NaHCO₃) or trona ore, which contains trona (Na₂CO₃.NaHCO₃.2H₂O) as well as impurities. U.S. Pat. No. 3,880,629 of Dulins et al lists these and many other naturally occurring sodium ores which may be used in glass making, more particularly for control of SO₂ emissions, but also as a component of the batch. Dulins et al use nahcolite, which may be calcined or uncalcined. Calcination is a process in which a substance is heated to a high temperature (which is however below its melting or fusing point) to bring about thermal decomposition or a phase transition in its physical or chemical constitution, e.g. to drive off water of crystallisation.

When trona ore is used to generate sodium carbonate having a purity of 99% for use in a float glass batch, because of the high level (approximately 10%) of impurities in the ore (such as silica (SiO₂), calcium oxide (CaO), alumina (Al₂O₃), potassium oxide (K₂O), iron oxides, sulphides and organic matter), it is conventional to purify the ore to eliminate most impurities by using complex and expensive processes such as the Sesquicarbonate Process or the Monohydrate Process (described by Donald D. Carr in Industrial Minerals and Rocks, 6^{th} Edition, 1994, pages 949 and 950). Such a high level of purity for the sodium carbonate was until now firmly thought to be required in order to meet the very high quality standards required of float glass. To achieve 99% purity with the Sesquicarbonate Process, the trona ore is subjected to a purification process which involves dissolution of the trona ore, followed by crystallisation of pure trona from the resulting solution; the pure trona is then calcined to produce soda ash according to the following reaction:

Na₂CO₃.NaHCO₃.2H₂O₍ₛ₎→3/2Na₂CO₃₍ₛ₎+1/2CO_{2(g)}+5/2H₂O_{(g)}

Alternatively with the Monohydrate Process, the trona ore itself is calcined, the resulting calcined trona ore dissolved in water and the solution crystallised to produce soda ash.

When trona ore is used to generate sodium carbonate for use in glass batches for other lower grades of glass, e.g. container glass, of lower quality than float glass, U.S. Pat. No. 5,470,554 describes that the soda ash can be provided from less highly purified trona ore, such that the resultant sodium carbonate has a lower purity of 95 to 99%. Such material may be obtained by upgrading trona ore using less complex and less expensive (both as compared to the dissolution processes referred to above) dry beneficiation processes including density separation and electrostatic separation.

For the avoidance of doubt, in the present specification and claims, the expression “trona ore” is used to refer to both the ore as recovered from natural sources and such ore which has been subjected to one or more beneficiation steps (which do not involve dissolution and crystallisation of trona). The term “trona” (as opposed to “trona ore”) is used to refer to the sodium sesquicarbonate Na₂CO₃.NaHCO₃.2H₂O produced by dissolution of the trona ore and crystallisation.

However, the processing required to produce high purity soda ash or trona from trona ore remains expensive, and it would be desirable to reduce costs by reducing the processing involved when trona ore is used as a source of sodium in glass making.

It is believed that trona ore may have previously been used directly in glass making. In his book Natural Soda Ash Occurrences, Processing and Use (Van Nostrand Reinhold, N.Y., 1992), Donald E Garret reports that “ . . . throughout the centuries the trona from the Wadi Natrun has been employed for the production of paper, soaps and detergents, glass making, embalming . . . . Some “natrun” may have been leached and recrystallised to produce a purer soda ash, but the bulk of it appears always to have been used directly as the mineral trona from the lake bed after the adhering muds and brine had been washed away”. More recently is appears that trona ore has again been proposed for direct use as a glass making ingredient. JP 10-139423 A describes a method of manufacturing soda ash for use as a glass making raw material in which trona ore is crushed and subsequently calcined in an atmosphere containing oxygen at 500-800° C. for at least five minutes.

However, there is no suggestion in either of these publications that trona ore (calcined or uncalcined) might have been used directly in glass making when high quality float glass was required e.g. for architectural or automotive glazing. Conventional wisdom in the field of glass manufacture has hitherto suggested that direct use of trona ore may be acceptable in lower quality glass making, where homogeneity and seed inclusion in the glass are not as critical as with float glass—“the quality requirements with respect of homogeneity and permitted seed content are higher [for float glass] than those for container glass” according to Wolfgang Trier in Glass Furnaces: Design, Construction and Operation (Society of Glass Technology, Sheffield, 2000) and “how much refining is done depends on the desired quality and properties of the glass, for example, manufacturers of flat and speciality glasses may have higher quality requirements and be willing to accept much fewer seeds than container glass” according to page 43 of a paper entitled “Energy and Environmental Profile of the US Glass Industry” (US Department of Energy, April 2002). However given the high level of free (organic) carbon observed in trona ore, the skilled man would certainly not expect trona ore to be useful for the production of float glass without being subjected to a complex and expensive purification process involving dissolution and recrystallisation. Given the very high purity (99%) of soda ash previously thought to be required for it to be suitable for use in float glass manufacture, use of trona ore itself would seem to go against all conventional teaching.

We have however found, most surprisingly, that satisfactory float glass production can be achieved using calcined trona ore directly as a glass batch constituent in place of soda ash, despite the impurities that the ore typically contains and in contradiction to the teaching in the field of float glass manufacture.

According to the present invention, there is provided a glass making method in which molten soda lime silica glass for forming into a float glass ribbon is produced by melting in a glass melting tank of a float glass production line a glass batch comprising silica sand, a source of calcium and a source of sodium oxide as fluxing agent, said source of sodium oxide being incorporated in the batch at least partially in the form of calcined trona ore, forming the molten glass into a float glass ribbon on a float bath, annealing the ribbon in a lehr, cooling the ribbon and cutting the ribbon into glass plates.

Surprisingly, we have found that such a method is suitable for the production of high quality float glass, for architectural and automotive uses where high glass quality is required, and the batch including calcined trona ore may be fed directly to the melting tank of a glass production line, including a float glass production line.

Typically the glass batch will comprise dolomite and/or limestone as the source of calcium.

When melting a glass batch for formation of float glass, the batch will normally be selected to produce a glass containing (in percentages by weight):

SiO₂: 65 to 75%, preferably 68 to 74%;

Na₂O: 10 to 18%, preferably 12 to 15%;

CaO: 4 to 14%, preferably 7 to 12%;

MgO: 0 to 5%, preferably 3 to 5%;

Al₂O₃: 0 to 5%, preferably 0 to 3%;

the amounts of silicon and metals present being expressed in terms of their oxides in conventional manner.

The sodium in the glass may be provided wholly or partly in the form of calcined trona ore. We prefer to use sufficient calcined trona ore to provide at least 20% of the sodium, and especially at least 40% of the sodium in the glass. Sodium sulphate (also known as saltcake), Na₂SO₄, will commonly be used as a refining agent and will provide a small proportion of the sodium in the glass. The balance will usually be provided by soda ash from a conventional source. It may however be that substantially 100% of the sodium in the glass is provided as calcined trona ore. The percentage inclusion is somewhat dependent though on the level of impurity in the ore and the effect that this may have on the final float glass product.

The trona ore used in the batch may contain a significant proportion of iron as impurity. Although such impurity may be disadvantageous when a clear glass (typically comprising between 0.07 and 0.135% by weight of total iron (expressed as Fe₂O₃)) is required, the presence of such iron impurity may be an advantage when the desired product is an iron containing glass, e.g. a body-tinted glass such as a blue, green, grey or bronze coloured glass, typically containing up to 2.1% by weight of total iron. For clear glass it may be necessary, depending on the impurity level, to separate at least a proportion of iron impurity, e.g. by a magnetic method, from the trona ore; other possible methods of reducing the iron content of the ore include selective mining, and when a higher proportion of iron is present in the finer particles, sieving these out.

Some trona ores are known to contain impurities inimical to glass making, for example, the Kenyan deposits, such as Lake Magadi, which, even after washing, may contain high proportions of sodium fluoride (>1%) and sodium chloride (>0.4%). These compounds are generally considered to be contaminants having an adverse effect in terms of both unwanted emissions and degradation of the structure of a furnace when included in a float-glass making batch. In operating the present invention the skilled man would obviously avoid the use of trona ores containing an unacceptably high proportion of impurities unsuitable for float glass production, and choose trona ore from sources free from such unacceptable high proportions of impurities inimical to the process he is operating. In this respect the trona ore deposits from the area of the Green River Valley, Wyo., are generally thought to provide an acceptable source.

In accordance with the invention, the trona ore is calcined, usually in an atmosphere of air, prior to incorporation in the final float glass batch. As stated earlier, the predominant source of sodium oxide present in trona ore is Na₂CO₃.NaHCO₃.2H₂O, and the process of calcining is used to remove chemically bonded water and convert sodium bicarbonate to sodium carbonate. Since the glass batch will normally be melted at a site remote from the trona ore extraction site, it is preferred to calcine the trona ore (with removal of water and carbon dioxide) before transporting it over long distances and adding it to a furnace, thereby reducing the weight of material to be transported, and to calcine the trona ore sufficiently to convert at least 50%, preferably at least 75%, especially at least 90% of the Na₂CO₃.NaHCO₃.2H₂O present to Na₂CO₃.

Removal of water has additional benefits (especially over use of uncalcined trona ore in a glass batch, which also appears to be possible). Firstly the cost of transporting the trona ore from where it is extracted to a glass making furnace is reduced (because the unit weight of the ore is reduced as a result of the water (and carbon dioxide) loss). Secondly the amount of energy required to heat calcined trona as a batch ingredient to the furnace temperature is reduced because of the amount of water and carbon dioxide that has already been driven off during pre-furnace calcination (and which therefore do not have to be heated). The energy saving may actually be quite significant—it may amount to up to around five therms per tonne (th/t) (compared to the energy required to heat uncalcined trona as a batch ingredient to furnace temperatures).

The sodium content (expressed as sodium oxide, Na₂O) of soda ash is approximately 58.5%, while the sodium content (expressed as Na₂O) of pure trona (Na₂CO₃.NaHCO₃.2H₂O) is approximately 41%. Typical trona ores may contain significant impurities, but it is preferred to use a trona ore containing at least 30%, and especially at least 35%, sodium (expressed as Na₂O). However, even when a “high” sodium oxide content trona ore is used (e.g. ore containing 45 to 50% sodium, expressed as Na₂O), it will be appreciated that the weight of trona ore required to provide a given sodium content in the glass batch is almost 50% greater than the corresponding weight of soda ash.

The time required for calcining will depend on the temperature used. The accompanying figure shows the time taken (in minutes on the abscissa, x) for trona ore to decompose to sodium carbonate (shown as percentage weight loss on the ordinate, y) at various calcination temperatures. At 350° C., decomposition was substantially complete by around 50 minutes, whilst at 200° C., it was substantially complete by around 120 minutes. While temperatures above 100° C. will normally be sufficient, we prefer to use a temperature above 150° C., especially a temperature above 170° C., to reduce the time required to complete the required degree of calcination. While increasing calcining temperature further above 200° C., preferably to around 350° C., will further reduce the time required for calcining, increases above around 450 to 475° C. are generally unnecessary and unlikely to be cost effective. A further advantage of calcining the trona ore is that the calcination process tends to drive off at least a proportion of any free carbon present as an impurity in the trona ore.

For a better understanding the present invention will now be more particularly described by way of non-limiting example.

A series of experimental melts were carried out to show the effect of replacing progressively increasing proportions of soda ash in a conventional clear float glass composition by initially using uncalcined trona ore (as a starting point in anticipation of using calcined trona ore). In the first melt (Comparative Example) a conventional clear float glass batch was used. In the subsequent melts (Examples 1, 2 and 3) the soda ash in the batch was progressively replaced with uncalcined trona in accordance with the following Table 1, in which all parts are by weight.

TABLE 1

| | Comparative | | | |
|---|---|---|---|---|
| | Example | Example 1 | Example 2 | Example 3 |
| Sand (SiO₂) | 739.5 | 736.4 | 733.35 | 727.53 |
| Soda Ash (conven- | 224.5 | 179.22 | 111.79 | 0.0 |
| tional source) | | | | |
| Uncalcined trona ore | — | 70.68 | 176.35 | 351.22 |
| Dolomite | 188.5 | 188.61 | 179.80 | 170.00 |
| Limestone | 48.9 | 45.95 | 46.77 | 45.24 |
| Saltcake | 9.1 | 9.05 | 9.05 | 9.05 |
| Batch Carbon | 0.28 | 1.3 | 3.2 | 6.3 |

In accordance with conventional practice, a small amount of anthracite was added to the batch of the Comparative Example, sufficient to provide a “batch carbon” of 0.28 grams. “Batch carbon” is the amount of free carbon included in the amount of batch used to produce 1 kilogram of glass (and includes indigenous contributions from the other batch components used); “free carbon” is the amount of carbon left after chemically combined carbon present as carbonates has been driven off e.g. by dissolving a sample in acid.

The uncalcined trona ore was from a deposit in Green River Area of Wyoming, USA. It was used without chemical processing, and was shown by analysis to contain, in percentages by weight, 37.6% sodium (expressed as Na₂O), 0.3% potassium (expressed as K₂O), 1.8% calcium (expressed as CaO), 0.8% magnesium (expressed as MgO), 0.5% aluminium (expressed as Al₂O₃), 0.23% iron (expressed as Fe₂O₃) and 1.8% free carbon. It was screened before use to remove particles having a dimension greater than 710 μm. The percentages of various particle sizes (in μm) used is as follows: 710 (0.041%); 500 (18.69%); 355 (15.74%); 250 (16.91%); 180 (9.83%); 90 (17.55%); <90 (21.23%).

Melts were prepared in the laboratory by the following procedure. Each batch was weighed, placed in a glass jar and dry mixed in a Turbula mixer for 20 minutes. The dry batch was placed in a “boat” made of 95% platinum/5% gold. The boat was fed into a tube furnace over a time period of two hours and then removed, so that successive incremental portions of each of the samples along the length of the boat were heated for progressively shorter periods. The furnace had a maximum temperature of 1480° C. On removal from the furnace the boat was left to cool until the melt was sufficiently viscous for the sample to be removed without deformation. The sample was then placed in an annealing oven at 550° C. for 1 hour before being cooled slowly to room temperature. The quality of each of the samples was assessed by observing the stage at which only ten batch stones could be seen, under low magnification, in a 1 cm×1 cm surface area, and determining the melting time corresponding to that stage.

Surprisingly, there were no significant differences in melting times at which only ten batch stones were present in the standard glass melt (Comparative Example) and in each of the uncalcined trona ore containing samples (Examples 1, 2 and 3). This positive result meant that a further melt was then carried out in accordance with the invention (Example 4) in which 100% of the soda ash in the batch was replaced with calcined trona in accordance with Table 2, in which all parts are again by weight.

TABLE 2

| | Comparative | |
|---|---|---|
| | Example | Example 4 |
| Sand (SiO₂) | 739.5 | 738.7 |
| Soda Ash (conventional | 224.5 | 0.0 |
| source) | | |
| Calcined trona ore | — | 252.1 |
| Dolomite | 188.5 | 171.4 |
| Limestone | 48.9 | 45.6 |
| Saltcake | 9.1 | 9.1 |
| Batch Carbon | 0.28 | 5.6 |

The calcined trona ore was from the same deposit as the uncalcined trona ore discussed earlier. It was calcined by heating 346.7 g of the uncalcined trona ore in a furnace at 200° C. for a time period of 2 hours. The resultant weight loss from the calcination was 27.3% (largely due to loss of water and carbon dioxide), with a residual content of 2.2% free carbon, sufficient to provide a batch carbon (as defined above) of 5.6 g in the batch of the Example. A melt using the calcined trona ore was prepared in the same way as for the melts using uncalcined trona ore, described earlier.

Surprisingly, there were no significant differences in melting times at which only ten batch stones were present in the standard glass melt (Comparative Example), and the calcined trona ore containing sample (Example 4), indicating that the batch used in the invention is suitable for float glass production.

The above result was particularly surprising in view of the high level of free carbon present in the calcined trona ore. High free carbon levels in the raw materials for glass manufacture normally result in very poor melting because the carbon reacts with the sulphate in the early stages of the melting and the ability of the melt to digest silica efficiently is lost. In the laboratory tests described above the maximum amount of carbon that can be added before the melting dramatically deteriorates is equivalent to around 1.0 batch carbon. It is highly surprising that Example 4 can be melted with no adverse effect on melting performance despite having nearly six times more free carbon than the normally expected maximum level. For some reason, not yet fully understood, the free carbon in the trona does not have the expected deleterious effect on melting performance.

If however a sample of trona ore was obtained for use in accordance with the present invention that had a batch carbon level that appeared to be too high (and problems with melting did begin to arise), it has been observed that increasing the temperature at which calcination of the trona ore occurs reduces the batch carbon level. This effect is illustrated in Table 3 below in which all parts are by weight.

TABLE 3

| Chemical | Calcination Temperature (Duration: 2 hours) | | | |
|---|---|---|---|---|
| Analysis (%) | 200° C. | 250° C. | 300° C. | 350° C. |
| Na₂O | 50.4 | 49.2 | 49.5 | 50.3 |
| K₂O | 0.59 | 0.60 | 0.58 | 0.58 |
| CaO | 2.33 | 2.31 | 2.30 | 2.14 |
| MgO | 1.39 | 1.37 | 1.30 | 1.31 |
| Al₂O₃ | 0.91 | 0.96 | 0.95 | 0.97 |
| Fe₂O₃ | 0.32 | 0.33 | 0.29 | 0.3 |
| Batch Carbon | 5.6 | 4.6 | 3.5 | 3.3 |

It is also possible that a sample of trona ore to be used in accordance with the present invention may have a lower batch carbon level of around 2 g, because of the intrinsic variability of organic matter inclusion in a trona ore source. It would however appear that samples of trona ore having a batch carbon level of between 2 g and 6 g could all be used successfully in float glass production.

1. A glass making method in which molten soda lime silica glass for forming into a float glass ribbon is produced by melting in a glass melting tank of a float glass production line a glass batch comprising silica sand, a source of calcium and a source of sodium oxide as fluxing agent, said source of sodium oxide being incorporated in the batch at least partially in the form of calcined trona ore, forming the molten glass into a float glass ribbon on a float bath, annealing the ribbon in a lehr, cooling the ribbon and cutting the ribbon into glass plates.

2. A method as claimed in claim 1 wherein sufficient calcined trona ore is used to provide at least 20% of the sodium in the glass.

3. A method as claimed in claimed in claim 2 wherein sufficient calcined trona ore is used to provide at least 40% of the sodium in the glass.

4. A method as claimed in claim 3 wherein calcined trona ore is used to provide substantially 100% of the sodium in the glass.

5. A method as claimed in claim 1 wherein the calcined trona ore contains iron mineral as an impurity and is used to produce an iron containing glass.

6. A method as claimed in claim 1 wherein the calcined trona ore contains at least 30%, and up to 55%, by weight sodium, expressed as sodium oxide.

7. A method as claimed in claim 6 where the calcined trona ore contains 45 to 50% by weight sodium, expressed as sodium oxide.

8. A method as claimed in any preceding claim 1 wherein at least 50% of the trona in the trona ore is converted to sodium carbonate during calcination.

9. A method as claimed in claim 8 wherein at least 90% of the trona in the trona ore is converted to sodium carbonate during calcination.

10. A method as claimed in claim 1 wherein the temperature at which calcination occurs is greater than approximately 100° C. but less than approximately 475° C.

11. A method as claimed in claim 10 wherein the temperature at which calcination occurs is around 170° C.

12. A method as claimed in claim 1 wherein satisfactory calcination of the trona ore occurs in less than 180 minutes.

13. A method as claimed in claim 12 wherein satisfactory calcination of the trona ore occurs in around 120 minutes.

14. A method as claimed in claim 1 wherein the temperature at which calcination occurs is greater than approximately 100° C. but less than approximately 450° C.
